(19) United States
(12) Patent Application Publication
(10) Pub. No.: US 2026/0110848 A1
(43) Pub. Date: Apr. 23, 2026

(54) METHODS AND TECHNIQUES FOR OPTICAL CIRCUIT SWITCHING

(71) Applicant: Lightmatter, Inc., Boston, MA (US)

(72) Inventors: Taylor Groves, Poulsbo, WA (US); Sriram Venkkatesan, Fremont, CA (US); Bradford Turcott, Georgetown, TX (US)

(73) Assignee: Lightmatter, Inc., Boston, MA (US)

(21) Appl. No.: 19/362,256

(22) Filed: Oct. 17, 2025

Related U.S. Application Data
(60) Provisional application No. 63/709,373, filed on Oct. 18, 2024.
(60) Provisional application No. 63/762,442, filed on Feb. 24, 2025.
(60) Provisional application No. 63/806,426, filed on May 15, 2025.

(51) Int. Cl. G02B 6/35

(52) U.S. Cl. CPC G02B 6/356; G02B 6/3546; G02B 6/3586; G02B 6/3594

(57) ABSTRACT

Described herein are systems and methods for dynamically configuring memory using Optical Circuit Switching (OCS). As electrical processing units such as accelerators are limited by their available bandwidth, providing disaggregated memory can help expand memory and enable better processing performance. Providing OCS devices to dynamically reconfigure processor-to-processor and processor-to-memory connections enables flexible reconfiguration of the disaggregated memory and improve performance of the system.

### RELATED APPLICATIONS

This application claims the benefit under 35 U.S.C. § 119(e) of U.S. Provisional Patent Application No. 63/709,373 filed Oct. 18, 2024, entitled “OPTICAL CIRCUIT SWITCHING FOR YIELD LOSS RECOVERY, U.S. Provisional Patent Application No. 63/762,442 filed Feb. 24, 2025, entitled “DYNAMIC NETWORK WITH OPTICAL CIRCUIT SWITCHING AND DARK FIBERS”, and U.S. Provisional Patent Application No. 63/806,426 filed May 15, 2025, entitled “OPTICAL CIRCUIT SWITCHING FOR DATA CENTERS,” each of which is hereby incorporated by reference herein in its entirety.

### BACKGROUND

Aspects of the present disclosure relate to an optical computing system. Optical interconnects are a type of communication technology that use light signals to transmit data between different components or devices within a system. These interconnects replace traditional electrical connections, such as copper wires or traces on a circuit board, with optical fibers or waveguides. In optical interconnects, data is converted into light using optical transmitters, typically lasers or light-emitting diodes (LEDs). These optical signals travel through optical fibers or waveguides, which are made of materials that can efficiently guide and transmit light with minimal loss. At the receiving end, optical receivers convert the incoming light signals back into electrical signals that can be processed by electronic devices. Optical interconnects can be used to connect various components of the optical computing system and can be configured to route optical signals throughout the system.

### SUMMARY

Optical circuit switching (OCS) has properties that are useful for various forms of communication, such as direct connection of optical signals between two points in a network using light instead of electrical signals. Compared to electrical circuit switching, OCS is considered higher bandwidth, lower latency, more energy efficient, and more scalable. Described herein are methods and techniques that leverage OCS to provide improved efficiency, functionality, and scalability over conventional optical systems as well as their electronic counterparts. For example, methods and techniques described herein relate to leveraging OCS for yield loss recovery and enable dynamic networking that can facilitate scale-up and scale-out functionality and expand memory.

According to some aspects described herein, a device is provided comprising: a plurality of electrical processing units; a plurality of optical channels having a plurality of chip-to-fiber couplers; an optoelectronic switch coupled between the plurality of optical channels and the plurality of electrical processing units; and a controller configured to: determine information indicative of a performance associated with each of the plurality of optical channels; determine information indicative of a performance associated with each of the plurality of electrical processing units; and control the optoelectronic switch to selectively couple at least a subset of the plurality of the electrical processing units with respective ones of at least a subset of the plurality of the optical channels based on the determined information indicative of the performances of the plurality of electrical processing units and the determined information indicative of the performances of the plurality optical channels.

In some embodiments, the optoelectronic switch is part of a photonic integrated circuit operatively coupled with an electronic integrated circuit.

In some embodiments, the electronic integrated circuit comprises the controller.

In some embodiments, the controller is configured to control the optoelectronic switch at least by: coupling a first electrical processing unit of the plurality with a first optical channel when the information indicative of the performance associated with the first optical channel indicates expected performance metrics of the first optical channel; and coupling the first electrical processing unit with a second optical channel when the information indicative of the performance associated with the first optical channel indicate failure of expected performance metrics of the first optical channel.

In some embodiments, the first optical channel is disposed adjacent to the first electrical processing unit; and the second optical channel is disposed non-adjacent to the first electrical processing unit.

In some embodiments, the controller is configured to control the optoelectronic switch at least by: coupling a first electrical processing unit with a first optical channel when the information indicative of the performance associated with the first electrical processing unit indicates expected performance metrics of the first electrical processing unit; and coupling a second processing unit with the first optical channel when the information indicative of the performance associated with the first processing unit indicates failure of expected performance metrics of the first electrical processing unit.

In some embodiments, the device further comprises at least one optical sensor and wherein the controller is configured to determine information indicative of a performance associated with each of the plurality of optical channels using a signal from the optical sensor indicative of the performance associated with at least one of the optical channels.

In some embodiments, the device further comprises a plurality of high bandwidth memories operatively coupled to the plurality of electrical processing units.

In some embodiments, the device further comprises at least one optoelectronic (OE) converter coupled between the plurality of electrical processing units and the plurality of optical channels.

In some embodiments, the optoelectronic switch is coupled to the at least one OE converter, wherein the controller is further configured to: determine information indicative of a performance associated with each of the at least one OF converter; and control the optoelectronic switch to selectively at least the subset of optical channels, at least the subset of electrical processing units, and the at least one OE converter based on the information indicative of the performance associated with each of the at least one OF converter.

In some embodiments, the electrical processing units comprise graphics processing units (GPUS).

In some embodiments, the electrical processing units and the optoelectronic switch are disposed on a common substrate.

According to some aspects described herein, a method is provided for configuring a device comprising a plurality of electrical processing units and a plurality of optical channels, and an optoelectronic switch being coupled between the plurality of electrical processing units and the plurality of optical channels, the method comprising: determining information indicative of a performance associated with each of the plurality of optical channels; determining information indicative of a performance associated with each of the plurality of electrical processing units; and controlling the optoelectronic switch to selectively couple at least a subset of the plurality of the electrical processing units with respective ones of at least a subset of the plurality of the optical channels based on the determined information indicative of the performances of the plurality of electrical processing units and the determined information indicative of the performances of the plurality of optical channels.

In some embodiments, controlling the optoelectronic switch to selectively couple at least the subset of the plurality of the electrical processing units with respective ones of at least the subset of the plurality of optical channels comprises: coupling a first electrical processing unit of the plurality with a first optical channel when the information indicative of the performance associated with the first optical channel indicates expected performance metrics of the first optical channel; and coupling the first electrical processing unit with a second optical channel when the information indicative of the performance associated with the first optical channel indicate failure of expected performance metrics of the first optical channel.

In some embodiments, controlling the optoelectronic switch to selectively couple at least the subset of the plurality of the electrical processing units with respective ones of at least the subset of the plurality of optical channels comprises: coupling a first electrical processing unit with a first optical channel when the information indicative of the performance associated with the first electrical processing unit indicates expected performance metrics of the first electrical processing unit; and coupling a second processing unit with the first optical channel when the information indicative of the performance associated with the first processing unit indicates failure of expected performance metrics of the first electrical processing unit.

In some embodiments, determining the information indicative of a performance associated with each of the plurality of optical channels comprises: receiving a signal from at least one optical sensor indicative of the performance associated with at least one of the optical channels; and determining the information based at least in part on the signal.

According to some aspects described herein, a non-transitory computer-readable medium storing instructions is provided that, when executed by at least one processor, perform a method for configuring a device comprising a plurality of electrical processing units and a plurality of optical channels, and an optoelectronic switch being coupled between the plurality of electrical processing units and the plurality of optical channels, the method comprising: determining information indicative of a performance associated with each of the plurality of optical channels; determining information indicative of a performance associated with each of the plurality of electrical processing units; and controlling the optoelectronic switch to selectively couple at least a subset of the plurality of the electrical processing units with respective ones of at least a subset of the plurality of the optical channels based on the determined information indicative of the performances of the plurality of electrical processing units and the determined information indicative of the performances of the plurality of optical channels.

In some embodiments, controlling the optoelectronic switch to selectively couple at least the subset of the plurality of the electrical processing units with respective ones of at least the subset of the plurality of optical channels comprises: coupling a first electrical processing unit of the plurality with a first optical channel when the information indicative of the performance associated with the first optical channel indicates expected performance metrics of the first optical channel; and coupling the first electrical processing unit with a second optical channel when the information indicative of the performance associated with the first optical channel indicate failure of expected performance metrics of the first optical channel.

In some embodiments, controlling the optoelectronic switch to selectively couple at least the subset of the plurality of the electrical processing units with respective ones of at least the subset of the plurality of optical channels comprises: coupling a first electrical processing unit with a first optical channel when the information indicative of the performance associated with the first electrical processing unit indicates expected performance metrics of the first electrical processing unit; and coupling a second processing unit with the first optical channel when the information indicative of the performance associated with the first processing unit indicates failure of expected performance metrics of the first electrical processing unit.

In some embodiments, determining the information indicative of a performance associated with each of the plurality of optical channels comprises: receiving a signal from at least one optical sensor indicative of the performance associated with at least one of the optical channels; and determining the information based at least in part on the signal.

According to some aspects described herein, a system is provided comprising: photonic integrated circuit (PIC) comprising: a first I/O interface configured to be coupled to a host device; a second I/O interface; and a first optical switch stage coupling the first I/O interface and the second I/O interface; a plurality of second optical switch stages; and a plurality of fibers coupling the second I/O interface of the PIC to the plurality of second optical switch stages.

In some embodiments, the system further comprises: a controller configured to select at least a first fiber of the plurality of fibers through which an optical signal should be transmitted between the host device and a respective second optical switch stage associated with the first fiber.

In some embodiments, the controller is configured to select at least the first fiber by: identifying at least one second optical switch stage associated with transmission of the optical signal; identifying the first fiber based on the identification of the at least one second optical switch stage; and setting a first fiber connection of the first optical switch stage coupled with the first fiber to an active configuration, wherein the active configuration enables transmission of the optical signal between the identified at least one second optical switch stage and the host device through the first fiber.

In some embodiments, the second optical switch stages each comprise a plurality of optical switches coupled to respective fibers of the plurality of fibers.

In some embodiments, the controller is configured to select at least the first fiber by: identifying at least one second optical switch stage associated with transmission of the optical signal; identifying fibers coupled to the at least one second optical switch stage; and setting at least one fiber connection associated with the identified fibers to an active configuration, wherein the active configuration enables transmission of an optical signal between the identified at least one second optical switch stage and the host device through at least one of the identified fibers.

In some embodiments, the host device comprises a plurality of electrical processing units.

In some embodiments, the plurality of electrical processing units comprise graphics processing units (GPUs).

In some embodiments, the plurality of electrical processing units comprise respective optical switch stages.

In some embodiments, the first optical switch stage comprises the optical switch stage of a first electrical processing unit; and the second optical switch stages comprise the optical switch stages of at least a subset of electrical processing units of the plurality of electrical processing units other than the first electrical processing unit.

In some embodiments, the electrical processing units are grouped into pods; the first electrical processing unit is grouped within a first pod; and the at least a subset of other electrical processing units comprise electrical processing units grouped within pods other than the first pod.

In some embodiments, each electrical processing unit is operatively coupled with one or more packet switches.

In some embodiments, the PIC comprises at least one of a transmitter and/or a receiver.

In some embodiments, the first I/O interface is configured to be coupled with the host device through integration of the first optical switch stage with the host device.

According to some aspects described herein, a method is provided of controlling a system comprising a photonic integrated circuit (PIC) having a first I/O interface configured to be coupled to a host device, a second I/O interface, and a first optical switch stage coupling the first I/O interface and the second I/O interface; a plurality of second optical switch stages; and a plurality of fibers coupling the second I/O interface of the PIC to the plurality of second optical switch stages, the method comprising: identifying at least one second optical switch stage associated with transmission of an optical signal; identifying the first fiber based on the identification of the at least one second optical switch stage; and setting a first fiber connection of the first optical switch stage coupled with the first fiber to an active configuration, wherein the active configuration enables transmission of the optical signal between the identified at least one second optical switch stage and the host device through the first fiber.

In some embodiments, each of the second optical switch stages comprise a plurality of optical switches and identifying at least one second optical switch stage comprises identifying a group of optical switches of the second optical switch stage associated with the transmission of the optical signal.

In some embodiments, setting a first fiber connection of the first optical switch stage to an active configuration comprises setting a first group of fiber connections of the first optical stage associated with the identified group of optical switches to the active configuration.

In some embodiments, the method comprises using a controller to set the first fiber connection to the active configuration.

According to some aspects described herein, a non-transitory computer-readable medium storing instructions thereon is provided that, when executed by at least one processor, cause the at least one processor to perform a method of controlling a system comprising a photonic integrated circuit (PIC) having a first I/O interface configured to be coupled to a host device, a second I/O interface, and a first optical switch stage coupling the first I/O interface and the second I/O interface; a plurality of second optical switch stages; and a plurality of fibers coupling the second I/O interface of the PIC to the plurality of second optical switch stages, the method comprising: identifying at least one second optical switch stage associated with transmission of an optical signal; identifying the first fiber based on the identification of the at least one second optical switch stage; and setting a first fiber connection of the first optical switch stage coupled with the first fiber to an active configuration, wherein the active configuration enables transmission of the optical signal between the identified at least one second optical switch stage and the host device through the first fiber.

In some embodiments, each of the second optical switch stages comprise a plurality of optical switches and identifying at least one second optical switch stage comprises identifying a group of optical switches of the second optical switch stage associated with the transmission of the optical signal.

In some embodiments, setting a first fiber connection of the first optical switch stage to an active configuration comprises setting a first group of fiber connections of the first optical stage associated with the identified group of optical switches to the active configuration.

According to some aspects described herein, a system is provided comprising: a first plurality of photonic integrated circuits (PICs), each PIC of the first plurality being coupled to at least one high bandwidth memory (HBM); a second plurality of PICs, each PIC of the second plurality being coupled to at least one electronic processing unit; and a first plurality of optical fibers coupling the first plurality and second plurality of PICs.

In some embodiments, the system further comprises a second plurality of optical fibers coupling PICs of the second plurality with other PICs of the second plurality.

In some embodiments, each of the PICs of the first plurality and second plurality comprises an optical switch coupled to at least some of the first plurality of optical fibers and at least some of the second plurality of optical fibers.

In some embodiments, the system further comprises at least one controller configured to control the optical switches, wherein the controller is configured to control the optical switches by: switching a first optical connection of the optical switch from an inactive configuration to an active configuration to enable optical signals to be transmitted through a first optical fiber of the first plurality of optical fibers or a first optical fiber of the second plurality of optical fibers or from the active configuration to the inactive configuration to prevent optical signals from being transmitted through the first optical fiber.

In some embodiments, the controller is configured to control the optical switches by: setting optical connections of the optical switches associated with the first plurality of optical fibers to an active configuration; and setting optical connections of the optical switches associated with the second plurality of optical fibers to an inactive configuration.

In some embodiments, the controller is configured to control the optical switches by: setting optical connections of the optical switches associated with the second plurality of optical fibers to an active configuration; and setting optical connections of the optical switches associated with the first plurality of optical fibers to an inactive configuration.

In some embodiments, the optical switches each comprise a plurality of 2×2 optical switches arranged in a Benes architecture.

In some embodiments, the plurality of 2×2 optical switches comprise directional couplers.

In some embodiments, each PIC of the first and second plurality comprises at least one electro-optical transceiver configured to: generate an electrical signal based on a received optical signal; and generate an optical signal based on a received electrical signal.

In some embodiments, each electronic processing unit comprises at least one internal memory.

In some embodiments, the first and second pluralities of PICs are reticle stitched.

According to some aspects described herein, a method is provided for dynamically configuring a system, the system comprising a first plurality of photonic integrated circuits (PICs), each PIC of the first plurality being coupled to at least one high bandwidth memory (HBM), a second plurality of PICs, each PIC of the second plurality being coupled to at least one electronic processing unit, and a first plurality of optical fibers coupling the first plurality and second plurality of PICs, the method comprising: setting optical connections associated with the at least one optical fiber of the first plurality of optical fibers to an active configuration, the active configuration enabling optical signals to be transmitted between a first PIC of the first plurality and a first PIC of the second plurality; and setting optical connections associated with other optical fibers of the first plurality of optical fibers to an inactive configuration, the inactive configuration preventing optical signals from being transmitted between the PICS of the first plurality and PICs of the second plurality associated with the other optical fibers.

In some embodiments, the system comprises a controller and each PIC of the first plurality of PICs and second plurality of PICs comprises an optical switch coupled to some of the first plurality of optical fibers, the method further comprising: receiving, with the controller, a signal indicating the at least one optical fiber of the first plurality of optical fibers to be set to the active configuration; and controlling the optical switches coupled with the at least one optical fiber to set the optical connections associated with the at least one optical fiber to the active configuration.

In some embodiments, the system further comprises a second plurality of optical coupling PICs of the second plurality of PICs with other PICs of the second plurality of PICS and the optical switches are each coupled to some of the second plurality of optical fibers, the method further comprising: controlling the optical switches to set optical connections associated with the first plurality of optical fibers to the active configuration; and controlling the optical switches to set optical connections associated with the second plurality of optical fibers to the inactive configuration.

In some embodiments, the system further comprises a second plurality of optical coupling PICs of the second plurality of PICs with other PICs of the second plurality of PICS and the optical switches are each coupled to some of the second plurality of optical fibers, the method further comprising: controlling the optical switches to set optical connections associated with the first plurality of optical fibers to the inactive configuration; and controlling the optical switches to set optical connections associated with the second plurality of optical fibers to the active configuration.

In some embodiments, controlling an optical switch comprises applying a signal to the optical switch to vary an optical property of the optical switch.

According to some aspects described herein, a non-transitory computer-readable medium storing instructions is provided that, when executed by at least one processor, cause the processor to perform a method for dynamically configuring a system, the system comprising a first plurality of photonic integrated circuits (PICs), each PIC of the first plurality being coupled to at least one high bandwidth memory (HBM), a second plurality of PICs, each PIC of the second plurality being coupled to at least one electronic processing unit, and a first plurality of optical fibers coupling the first plurality and second plurality of PICs, the method comprising: setting optical connections associated with the at least one optical fiber of the first plurality of optical fibers to an active configuration, the active configuration enabling optical signals to be transmitted between a first PIC of the first plurality and a first PIC of the second plurality; and setting optical connections associated with other optical fibers of the first plurality of optical fibers to an inactive configuration, the inactive configuration preventing optical signals from being transmitted between the PICS of the first plurality and PICs of the second plurality associated with the other optical fibers.

In some embodiments, the system comprises a controller and each PIC of the first plurality of PICs and second plurality of PICs comprises an optical switch coupled to some of the first plurality of optical fibers, the method further comprising: receiving, with the controller, a signal indicating the at least one optical fiber of the first plurality of optical fibers to be set to the active configuration; and controlling the optical switches coupled with the at least one optical fiber to set the optical connections associated with the at least one optical fiber to the active configuration.

In some embodiments, the system further comprises a second plurality of optical coupling PICs of the second plurality of PICs with other PICs of the second plurality of PICS and the optical switches are each coupled to some of the second plurality of optical fibers, the method further comprising: controlling the optical switches to set optical connections associated with the first plurality of optical fibers to the active configuration; and controlling the optical switches to set optical connections associated with the second plurality of optical fibers to the inactive configuration.

In some embodiments, the system further comprises a second plurality of optical coupling PICs of the second plurality of PICs with other PICs of the second plurality of PICS and the optical switches are each coupled to some of the second plurality of optical fibers, the method further comprising: controlling the optical switches to set optical connections associated with the first plurality of optical fibers to the inactive configuration; and controlling the optical switches to set optical connections associated with the second plurality of optical fibers to the active configuration.

### BRIEF DESCRIPTION OF THE DRAWINGS

Various aspects and embodiments will be described with reference to the following figures. It should be appreciated that the figures are not necessarily drawn to scale. Items appearing in multiple figures are indicated by the same or a similar reference number in all the figures in which they appear. In the figures:

FIG. 1A is a top-view block diagram of an example computing device leveraging optical circuit switching (OCS), according to some embodiments;

FIG. 1B is a side-view block diagram of the example computing device of FIG. 1A, according to some embodiments;

FIG. 2 is a flowchart of an example process for leveraging OCS on a computing device for improved manufacturing yield, according to some embodiments;

FIG. 3A is a block diagram of an example system leveraging OCS to enable a dynamic network, according to some embodiments;

FIG. 3B is a block diagram of another example system leveraging OCS to enable a dynamic network, according to some embodiments;

FIG. 4 is a block diagram of an example first stage optical switch of the example system of FIG. 3, according to some embodiments;

FIG. 5 is a block diagram depicting example compute pods of a system leveraging OCS to enable a dynamic network, according to some embodiments;

FIG. 6 is a block diagram of an example photonic computing system having disaggregated memory, according to some embodiments;

FIG. 7A is a block diagram of a subsection of the example system of FIG. 6, according to some embodiments;

FIG. 7B is a block diagram of a subsection of the example system of FIG. 6 depicting dark and lit optical fibers, according to some embodiments;

FIG. 8 is a block diagram illustrating an example implementation of an optical switch, according to some embodiments; and

FIG. 9 is an example computer system that may be used to implement some of the controllers described herein.

### DETAILED DESCRIPTION

### I. Overview

Optical circuit switching (OCS) utilizes optoelectronic switches to control the routing of optical signals throughout a photonic computing network. The inventors have recognized and appreciated that OCS can be leveraged for a multitude of beneficial uses. For example, as described herein, OCS can be used to improve manufacturing yield of photonic integrated circuits (PICs). As further described herein, OCS can also be used to facilitate scale-up and scale-out functionality by providing dynamic routing within a photonic network. Additionally, OCS can be used to expand memory capacity and bandwidth, using memory disaggregation, that may typically limit electronic accelerators. Although techniques described herein are described separately, it can be appreciated that the techniques may be used separately or in conjunction in any combination.

### II. Yield Loss Recovery

The inventors have recognized and appreciated that OCS may be leveraged to improve manufacturing yield of a PIC. For example, in some embodiments described herein, an OCS device may be integrated into an existing multi-fiber configuration having optoelectronic converters, where the OCS device acts as a reconfigurable optical router to route optical signals between various inputs and outputs. For example, in some embodiments, the OCS device may be integrated into a wavelength division multiplexing (WDM) architecture that may provide connections for a plurality of wavelengths of optical signal. By doing so, when a component of the PIC experiences a failure during the manufacturing process or during operation, the OCS can reroute the connections of the PIC to utilize the remaining functional components and mitigate yield loss. Further, the OCS device may include or be coupled with optoelectronic converters that can convert incoming electrical signals to optical signals prior to be routed through the OCS device to the optical channels and/or convert outgoing optical signals after being routed through the OCS device. In that way, the OCS can mitigate yield loss while enabling a computing device to support bidirectional communication in an optoelectronic communication network.

Conventional multi-fiber PIC computing devices utilize a 1:1:1 connection scheme of fibers to optoelectronic converters to electronic processing units. For example, a conventional PIC with eight processing units and eight fibers will also have eight optoelectronic converters. As an illustrative example, when either the processing unit or the fiber fails, a whole connection of the PIC is lost. Conventionally, GPU manufacturing has a 2% yield loss (i.e., on average, 2% of all GPUs are faulty) and optoelectronic converter manufacturing has a 2% yield loss (i.e., on average, 2% of all optoelectronic converters are faulty). Thus, the total yield loss for a single GPU/OE converter pair is about 4%. A conventional eight-GPU computing device will have a 27.6% probability of failure on at least one of the components (e.g., a 27.6% yield loss).

Conventional methods for “recovering” that yield employ downbinning where the manufacturers sell the faulty device as a lower-tier computing device. For example, if an eight-GPU device has one faulty GPU, then it may be sold as a less powerful seven-GPU device. Using conventional downbinning, the yield loss of the eight-GPU computing device may be reduced to 3.74%. However, the inventors have recognized and appreciated that conventional downbinning can result in a significant loss in revenue and does not mitigate the loss in functionality of the computing device caused by failed components.

The inventors have recognized that using an OCS device connected to multiple fibers and multiple processing units can further reduce the yield loss over conventional downbinning while mitigating the loss in functionality of the computing device caused by failed components. When one of the components experiences a failure, the OCS device can reroute the connections towards components that are functioning properly. Thus, employing an OCS device in the manner described herein enables at least a partial recovery of the yield lost due to a component experiencing a failure. For example, using an OCS enabled device results in a downbinned yield loss of only 2.94% rather than the 3.74% yield loss of conventional downbinning techniques. The overall yield loss is reduced by 21.5% by using the OCS-enabled device. As another example, with a four-GPU configuration, the downbinned yield loss is reduced by 17.2% from 0.89% yield loss provided by conventional downbinning techniques to 0.72% yield loss using an OCS-enabled device.

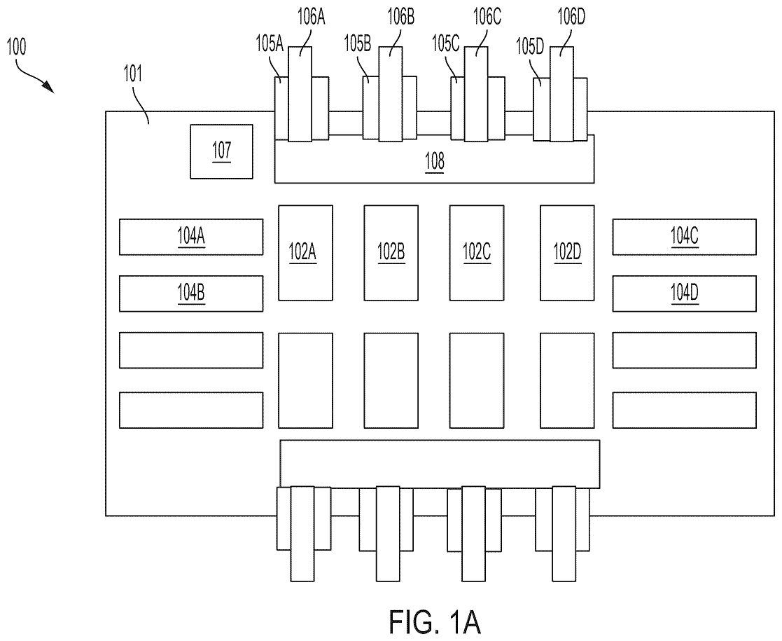

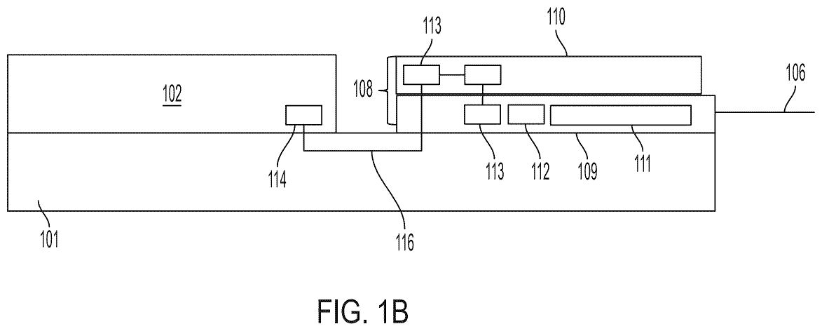

FIG. 1A is a top-view block diagram of an example computing device 100 leveraging OCS, according to some embodiments. In the illustrated embodiment, computing device 100 includes a plurality of electronic processing units 102 (e.g., units 102A-D), a plurality of memory units 104 (e.g., devices 104A-D), and one or more optoelectronic switches 108. In the illustrated embodiment, the aforementioned components are formed on a common substrate 101, although the technology is not limited in this manner. Further, electronic processing units 102 may be any suitable processing units for processing electrical signals and the memory units 104 may be any suitable memory unit. For example, the electronic processing units 102 may include one or more of CPUs, GPUs, TPUs, or any other type of electronic processing unit. Memory units 104 may include one or more of high bandwidth memory (HBM), RAM, low power double data rate (LPDDR) modules, or any other suitable memory unit. Each electronic processing unit 102 may be coupled to at least one memory unit 104.

Optoelectronic switch 108 is configured to be coupled to two or more optical fiber arrays 106 (e.g., four optical fiber arrays 106A-D as in the illustrated embodiment) and two or more of the plurality of electronic processing units 102A-D. To couple optical fiber arrays 106A-D to optoelectronic switch 108, computing device 100 may include respective optical channels 105A-D. Optical channels 105A-D include in-plane or out-of-plane chip-to-fiber couplers such as edge couplers, grating couplers, or any other suitable chip-to-fiber coupler. The electronic processing units 102A-D may be coupled with the optoelectronic switch in any suitable manner, including metal components (e.g., metal traces, through silicon vias) disposed on or in substrate 101. By coupling optoelectronic switch 108 between the optical channels 105 (and thus fiber arrays 106) and electronic processing units 102, optoelectronic switch 108 can route signals between the various components of computing device 100—for example, in the event of failure of one of the components during manufacturing or during operation.

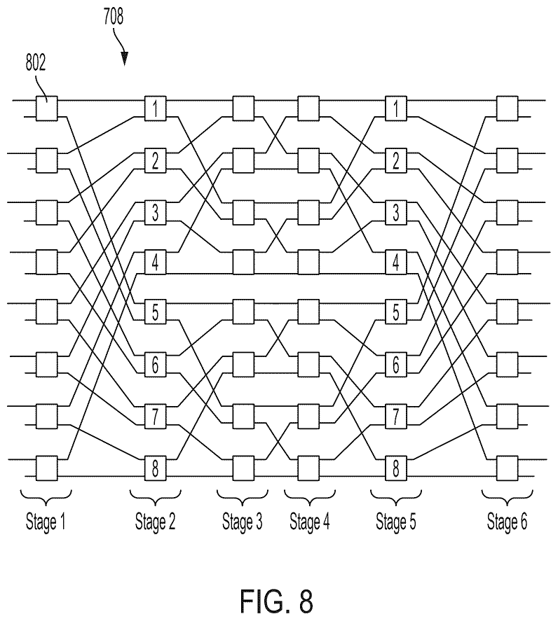

Optoelectronic switch 108 may have any suitable architecture for routing signals between different ports. Optoelectronic switch 108 as noted above, may have a plurality of optical ports for coupling with optical channels 105. Optical signals may be routed between ports by means of electronic control signals (e.g., with a controller). In some embodiments, optoelectronic switch 108 may route the optical signals without conversion of the signals to the electrical domain. In some embodiments, optoelectronic switch 108 includes one or more optoelectronic converters (e.g., as described with respect to FIG. 1B) to convert electrical signals to optical signals prior to being routed through optoelectronic switch 108 and/or convert optical signals to electrical signals after the optical signals have been routed through optoelectronic switch 108. As will be described further herein with respect to FIG. 8, an optoelectronic switch may comprise a series of directional couplers arranged in stages. For example, optoelectronic switch 108 may be implemented as a butterfly architecture, a Benes architecture, or any other suitable optical switching architecture. The architecture may enable an any-to-any connection between optical channels 105 and electronic processing units 102 and thus may have the same number of inputs and outputs as the device has channels and processing units. In other embodiments, groups of electronic processing units 102 and optical channels may be disposed in different regions of the device and each group may have its own optoelectronic switch 108. For example, in the illustrated embodiment, the labeled components may represent a first group and the unlabeled components may represent a second group. In the illustrated embodiment, the second group mirrors the first group and operates in the same manner as described above with respect to the first labeled group.

In some embodiments, computing device 100 includes controller 107 for controlling optoelectronic switch 108 to configure and route connections between the electronic processing units 102 and optical channels 105. Controller 107 may be configured to control optoelectronic switch 108 based on information indicative of the performances of the various electronic processing units 102 as well as the performances of the optical channels 105 and/or optical fiber arrays 106. Controller 107 may be configured to determine the information in any suitable manner. Although illustrated separately, in some embodiments, controller 107 may be integrated with optoelectronic switch 108 (e.g., may be formed as part of an ASIC bonded to the PIC hosting optoelectronic switch 108 or may be formed on the PIC itself).

When the information indicates that all of the components are properly performing, each electronic processing unit 102 may be coupled with respective optical channels 105 through optoelectronic switch 108. In some embodiments, the respective optical channels 105 are those adjacent or nearest their associated electronic processing unit. That is, electronic processing unit 102A may be coupled with optical channel 105A, electronic processing unit 102B with optical channel 105B, and so on.

When the information indicates that one or more of the components are not functioning properly, controller 107 may control optoelectronic switch 108 to reroute connections to maximize available component usage. For example, electronic processing units 102 may experience electrical faults or physical manufacturing faults (e.g., not properly secured or soldered to substrate 101) or the optoelectronic converters (e.g., OE converters 112 described with respect to FIG. 1B) may experience failures. Optical channels 105 and optical fiber 106 may experience coupling errors that introduce significant amounts of loss to the optical connection, or may experience other physical manufacturing errors such as non-uniform etching of the channels or kinks in the fiber. To maximize available component usage, controller 107 may control the optoelectronic switch 108 to reroute connections to couple non-adjacent pairs of electronic processing units 102 and optical channels 105 (e.g., 102A with 105B).

Consider an example in which both electronic processing unit 102B and optical channel 105C experience a failure. In conventional devices, a failure of both those components would result in a loss of two processing units as each processing unit has a direct one-to-one coupling with the optical channels. However, utilizing the techniques described herein, controller 107 can reroute the optical connections of optoelectronic switch 108 so that optical channel 105B is coupled with electronic processing unit 102C. In that way, rather than losing two processing units worth of processing power, electronic processing unit 102C is recovered so only electronic processing unit 102B is lost, thus reducing the yield lost during manufacturing.

FIG. 1B is a side-view block diagram of the example computing device 100 of FIG. 1A, according to some embodiments. In the illustrated embodiment, optoelectronic switch 108 is formed as part of a photonic integrated circuit 109 (PIC) and controller 107 is formed as part of an electronic integrated circuit 110 (EIC). While PIC 109 and EIC 110 are illustrated as a packaged stack, the technology is not limited in this manner and the PIC 109 and EIC 110 may be disposed separately.

PIC 109 includes the OCS architecture 111 described above. PIC 109 may further include one or more optoelectronic (OE) converters 112 for converting between optical signals and electrical signals (e.g., optical to electrical and/or electrical to optical) and a transceiver 113 for communicating with EIC 110 and the electronic processing unit 102. EIC 110 includes controller 107 (not pictured) for controlling the OCS architecture and, optionally, one or more other components of computing device 100 (e.g., transceiver 113 for communicating with PIC 109 and electronic processing unit 102.

OE converters 112 may receive optical signals from the OCS architecture 111 and convert the optical signals to electrical signals to be transmitted to electronic processing unit 102. Additionally or alternatively, OE converters 112 may receive electrical signals received from electronic processing unit 102 and convert them to optical signals for transmission out through fiber array 106.

To facilitate communication between EIC 110 and electronic processing unit 102, the computing device 100 may include connection pathway 116. Connection pathway 116 may comprise a conductive path from EIC 110 to electronic processing unit 102. The conductive path may include through-silicon vias (TSV) and/or metal traces on or through various components of computing device 100 to form the connection. In the illustrated embodiment, connection pathway 116 includes TSVs into and metal traces through substrate 101.

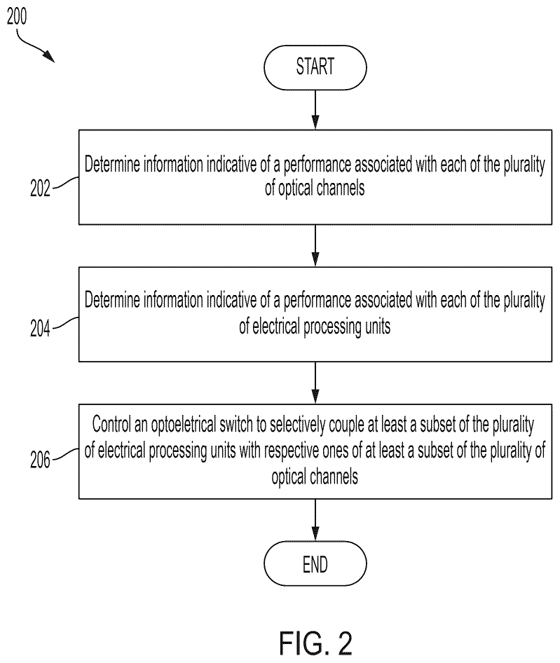

FIG. 2 is a flowchart of an example process 200 for leveraging OCS on a computing device for improved manufacturing yield, according to some embodiments. Process 200 begins at act 202 by determining information indicative of a performance associated with each of the plurality of optical channels and, at act 204, determining information indicative of a performance associated with each of the plurality of electrical processing units. Although depicted as separate steps, acts 202 and 204 may be performed in any order or concurrently as the technology is not limited in this manner. Further, acts 202 and 204 may be performed in any suitable manner.

In some embodiments, controller 107 is used to determine information indicative of a performance associated with each of the plurality of optical channels at act 202. For example, the device may include one or more optical sensors for detecting optical signals propagating through the optical fiber arrays and optical channels. The controller may receive a signal from the one or more optical sensors indicative of the performance of each of the fiber (e.g., via a performance metric) arrays and channels. In some embodiments, the signal may be indicative of an amplitude of the optical signal at the sensor point which can be compared with an expected amplitude. A loss in amplitude with respect to the expected amplitude may indicate that the channel, fiber array, or coupling therebetween is faulty. Alternatively or additionally, the optical sensor may provide a measure of misalignment between the channel and the fiber array which may indicate manufacturing fault.

The controller may additionally be used to determine information indicative of a performance associated with each of the plurality of electronic processing units at act 204. For example, the controller may receive one or more signals (e.g., test signals) from the electronic processing units. If the signal indicates fault or no signal is received from a particular unit, the controller may determine that the electronic processing unit is faulty. Alternatively, the controller may be used to determine information indicative of a performance associated with each of the plurality of electronic processing units by determining a bit error rate (BER).

Additionally or alternatively, in some embodiments, the controller may be used to determine information indicative of a performance associated with the OE converters. For example, the controller may receive one or more signals from the OE converters. If the signal indicates fault or no signal is received from a particular unit, the controller may determine that the OE converter is faulty.

Having determined information indicative of the performances of both the optical channels, the electrical processing units, and/or the optoelectronic converters, process 200 proceeds at act 206 to control an optoelectronic switch to selectively couple at least a subset of the plurality of electrical processing units with respective ones of at least a subset of the plurality of optical channels. The controller may determine pairs of functioning channels and processing units to minimize component loss (and maximize component utilization). The controller may default to coupling adjacent (or nearest) pairs of channels and processing units when both are functioning properly, but may couple non-adjacent pairs when an adjacent pair experiences a fault in either of the processing unit or channel.

The controller may control the optoelectronic switch in any suitable manner. For example, in embodiments where the optical switching architecture utilizes staged directional couplers, the controller may provide one or more electrical signals to the directional couplers to vary the optical properties of the directional coupler (e.g., refractive index). The varied electrical properties can change how optical signals propagate through the directional coupler stages, thus enabling coupling between various processing units and optical channels to mitigate yield loss.

### III. Improved Scale-Up and Scale-Out Functionality

OCS devices can also be used in data center networks to create optical connections between different compute elements. The inventors have recognized and appreciated that data center networks face limitations in their scale due to factors like port count (e.g., as the number of ports a switch can have is limited), insertion losses, power consumption, and the cost and complexity of building larger switches.

Conventional approaches for addressing the aforementioned problems include building larger, single-stage OCS switches to maximize port count. The larger, single-stage OCS systems may employ micro-electro-mechanical systems (MEMS) that utilize mirrors or other microscale devices to direct optical signals. MEMS devices can offer high port counts but are limited in switching speed and reliability. Other techniques utilize robotics to move optical fibers to provide connection flexibility, but are generally limited by their slow speeds. Even other techniques may employ guided waves using optical waveguides to direct light on a chip. Guided waves may offer fast switching speeds but are limited in port count. Some of the single-stage OCS devices may use piezoelectric materials to move optical components or may utilize wavelength switching where different wavelengths of light establish different connections, enabling multiple connections on the same fiber where each of the connections may be associated with a different wavelength. As one example, one conventional approach utilizes a layer of MEMS OCS outside of a host compute device to split connections across multiple “rails,” with a dedicated OCS for each rail. While this approach may help distribute and manage the connections, it still relies on individual, large MEMS devices.

The inventors have further recognized and appreciated that existing scale-out network architectures provide substantially lower bandwidth between the scale-up network processing (e.g., GPU) pods. Scale-up architecture refers to adding resources (e.g., memory, processing units) to a single machine to enhance performance and improve capacity of the machine. Scale-out architecture refers to adding additional compute nodes to a distributed system to improve the performance and capacity of the entire system. A “pod” refers to a highly-connected group of electronic processing units (e.g., GPUs, TPUs, etc.), typically with HBM-levels of bandwidth (compared to Ethernet, which is typically an order of magnitude slower). GPUs in a pod are typically physically near one another and include on the order of 512 GPUs (as compared to the entire system of the data center, which includes hundreds of thousands of GPUs).

A typical ethernet network interface controller (NIC) may provide 800 Gbps whereas a scale-up bandwidth may be 7,200 Gbps or more per GPU. These existing scale-out networks are built to support any-to-any connectivity at scales of 100,000+ endpoints. This requires multiple layers of packet switching and greatly increases transceiver costs. Because of the increased infrastructure, bandwidth is often limited and/or tapered to reduce costs. Further, conventional systems typically employ an external, central OCS device where all processing units are connected to the central OCS. As noted above, this architecture configuration limits the bandwidth and scalability of the system.

Accordingly, the inventors have developed the techniques and systems herein that leverage OCS devices distributed to individual host compute devices. For example, each compute device may include an initial first stage OCS device. By distributing the OCS to be provided with the host compute device, the network can be made dynamic and reconfigurable through control of the OCS devices. Further, distributed OCS devices can increase scalability and bandwidth over central OCS implementations that are limited by the bandwidth and port count of a single, large, central OCS device. The techniques described herein provide increased bandwidth and scalability by leveraging scale-up bandwidth to provide additional scale-out bandwidth.

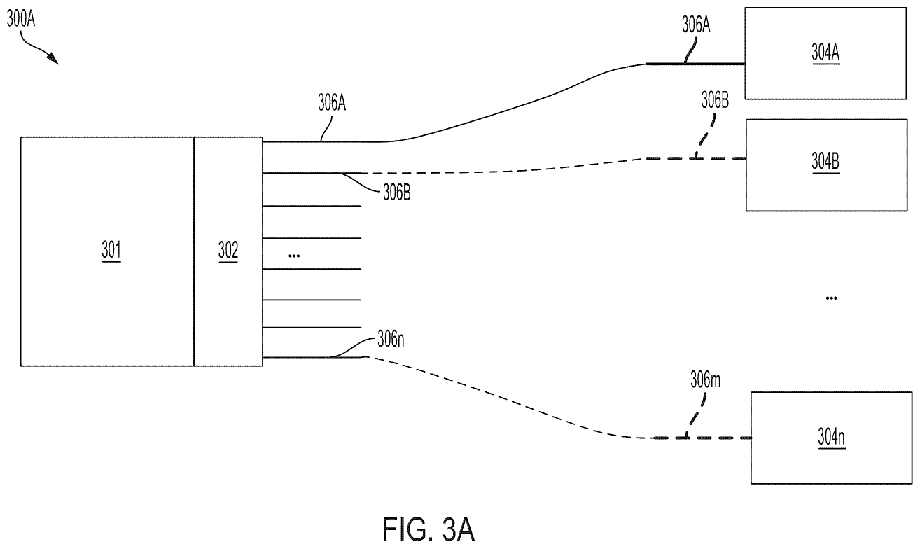

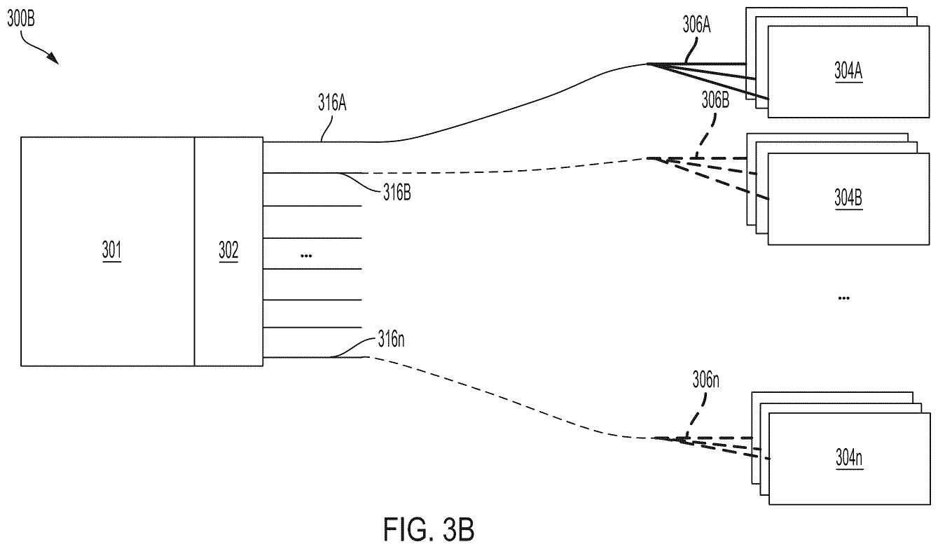

FIG. 3A is a block diagram of an example system 300A leveraging OCS to enable a dynamic network, according to some embodiments. In the illustrated embodiment, system 300A includes host device 301, a first stage optoelectronic switch 302 coupled with host device 301, a plurality of second stage optoelectronic switches 304A-n, and a plurality of optical fibers 306A-n coupling the first stage optoelectronic switch 302 with the second stage optoelectronic switches 304A-n. By including a first stage optoelectronic switch 302 coupled with the host device 301, optical connections between host devices or other components can be selectively turned on and off prior to signals leaving the host device 301, where some optical fibers may be dark (e.g., not transmitting an optical signal) and some are lit (e.g., able to transmit or transmitting optical signals), enabling dynamic networking and improving scalability of the network. Host device 301 may be any suitable device comprising one or more processing units. For example, host device 301 may be a single electrical processing unit (CPU, GPU, TPU) or may be a system comprising multiple electrical processing units.

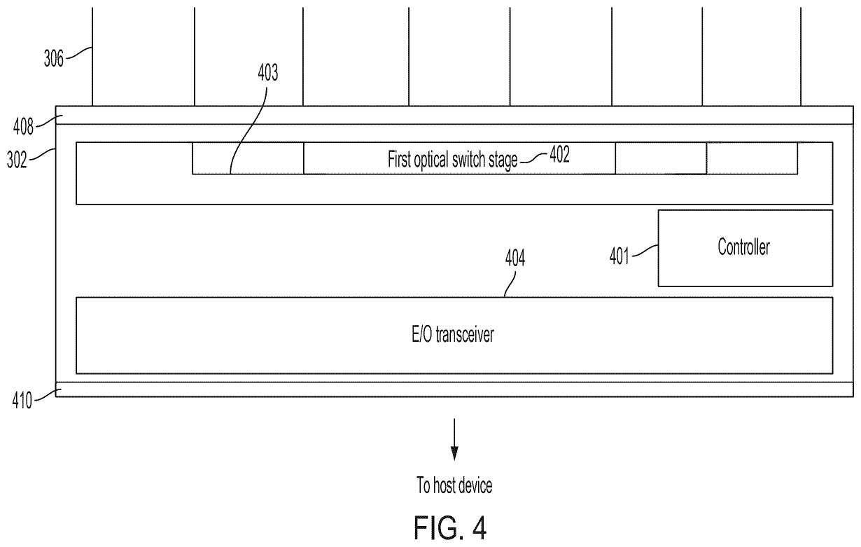

First stage optoelectronic switch 302 may be implemented as a PIC or a photonic interposer. FIG. 4 is a block diagram of an example first stage optoelectronic switch 302 of the example system of FIG. 3A, according to some embodiments. In the illustrated embodiment, first stage optoelectronic switch 302 is configured to be coupled to host device 301 at interface 410 on a first side of first stage optoelectronic switch 302. The first stage optoelectronic switch 302 is further configured to be coupled to the plurality of second stage optoelectronic switches 304 through interface 408 on a second side of the first stage optoelectronic switch 302. First stage optoelectronic switch 302 includes the first optical switch stage 402, controller 401, and E/O transceiver 404 to convert between the optical and electrical domains.

First optical switch stage 402 may be configured in any suitable manner to route signals along different connection pathways between host device 301 and second stage optoelectronic switches. For example, first optical switch stage 402 may be configured as a series of staged directional couplers as described with respect to FIG. 8. Although only eight fibers are shown, first optical switch stage 402 may be configured to support any suitable number of optical connections including 2, 4, 8, 16, 32, 64, 128, 256, or more, to facilitate the dynamic networking capabilities described herein.

Controller 401 may be configured to control first optical switch stage 402 to route signals and perform aspects of the dynamic networking configuration capabilities described herein. In some embodiments, controller 401 control first optical switch stage 402 by first identifying one or more second stage optoelectronic switches 304 associated with signals to be routed. For example, controller 401 may receive signals associated with various second stage optoelectronic switches 304 and may determine which signals to route where. Additionally or alternatively, host device 301 may provide one or more instructions to controller 401 to control the routing of first optical switch stage 402. Controller 401 may then identify which fibers optically couple the first stage optoelectronic switch 302 with the identified second stage optoelectronic switch 304 and can control the optical connection associated with that fiber to an active configuration, enabling signals to be transmitted between the host device 301 and the identified second stage optoelectronic switch 304. The controller 401 may additionally determine that a lit fiber should be turned inactive, and can set the optical connections associated with that fiber to the inactive configuration to prevent any signal transmission through that fiber.

In some embodiments, the second stage optoelectronic switches 304 may include groups of optical switches—for example, a group of 16 top-of-rack (TOR) optical switches associated with a server in a data center. Conventional systems could only connect to one of these systems. However, the systems described herein can dynamically route between groups of optical switches using the distributed OCS scheme to choose the fibers associated with a desired group. FIG. 3B is a block diagram of another example system 300B leveraging OCS to enable a dynamic network, according to some embodiments. In the illustrated embodiment, fiber arrays 316 each include a plurality of fibers 306. Rather than setting individual fibers on as in the example system 300A, the first stage optoelectronic switch 302 of system 300B can set optical connections with the entire fiber array 316 to an active configuration so that signals can be transmitted to the entire group of second stage optoelectronic switches 304. In one example, using a first stage optoelectronic switch 302 configured for 256 ports, the network capacity can be increased from 16 connections (e.g., one group of TOR switches) to 256 connections which provides connections to 16 different groups of TOR switches.

As further noted above, the techniques described herein can be used to dynamically route and reroute a network, e.g., as in a data center. This can be used to maximize bandwidth usage by distributing bandwidth between scale-up and scale-out bandwidth as needed—especially for high bandwidth workloads like machine learning, artificial intelligence, and other high performance computing workloads. The inventors have recognized and appreciated that, to reduce latency and energy consumption, it is desirable to distribute (statically or dynamically) the decoding of wavelengths to be near the outgoing port, eliminating the need for extensive electrical routing. In some examples, this involves optically demultiplexing wavelengths and using on-chip waveguides for transport. OCS can improve bandwidth compared to typical Ethernet connections. In data centers, current scale-out networks provide lower bandwidth between scale-up network processing pods compared to the bandwidth within a scale-up pod. Some embodiments include a combination of additional “dark” fibers and OCS on the electrical processing units to repurpose the substantial scale-up bandwidth temporarily to support cross-pod collectives (e.g., all-to-all over torus topology of one or more dimensions). Additionally, the inter-pod connectivity enables a secure set of connections as they allow for physical isolation between one or more Pods in the system.

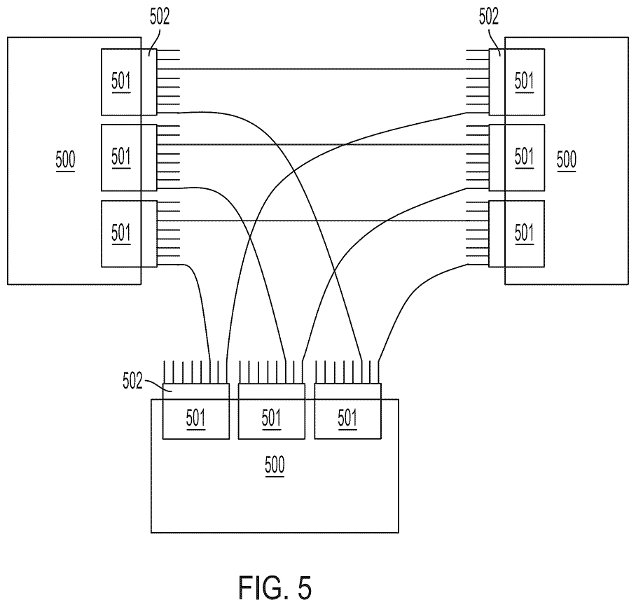

FIG. 5 is a block diagram depicting example compute pods 500 of a system leveraging OCS to enable a dynamic network, according to some embodiments. In the illustrated embodiment, each pod 500 comprises a plurality of electrical processing units 501, each of which include a respective OCS device 502. The OCS device 502 may be implemented on a common substrate as the electrical processing units 501. Although not pictured, each of the electrical processing units may be coupled to each packet switch in the pod. The intra-pod connectivity may support terabyte per second levels of bandwidth between the processing units and packet switches.

To facilitate dynamic network rerouting, each of the electrical processing units 501 is coupled with a respective electrical processing unit 501 of the other two pods. The fibers and fiber arrays coupling the respective electrical processing unit 501 may initially be inactive. That is, no signal can be transmitted over those fibers. When the system determines more bandwidth is needed for a process than is available in a pod 500, the system (e.g., using one or more controllers) may cause another pod 500 to provide bandwidth to support the process and may selectively enable the connections between the pods using their respective OCS devices 502. That way, the process can be handled in a distributed manner, rather than suspending the process until there is available bandwidth in the pod.

In some embodiments, a central OCS (not pictured) may be used. In those embodiments, most if not all of the connections may first be transmitted to the central OCS from their respective host-stage OCS devices 502, before reaching its final destination. However, in some embodiments, some optical connections may be configured to bypass the central OCS device and be connected directly from host device to host device.

The implementations illustrated in FIGS. 3A-3B, 4 and 5 may be further configured to support schemes for yield loss recovery, examples of which are illustrated in FIGS. 1A-1B.

### IV. Memory Expansion and Disaggregated Memory

The inventors have further recognized and appreciated that OCS devices can further provide dynamic memory expansion in disaggregated memory systems. The inventors have recognized and appreciated that processing units, especially higher speed processing units, are limited by the available memory capacity and bandwidth of the host device. For devices employing HBM, the limits are imposed by the bandwidth density per stack of HBM and the interposer and substrate size which prevent additional stacks of HBM from being added. For off-package memory (e.g., LPDDR modules), the limits are set by the shoreline I/O to a processing device and the area required to place the modules.

One conventional approach for addressing the aforementioned limits is to place the memory off the board or tray in a disaggregated architecture. However, disaggregated memory schemes are limited by copper reach (the distance a copper interconnect can carry a signal which decreases as data rates increase) and the additional costs of adding optical connectivity. Further, conventional systems employing disaggregated memory have a static, fixed stage of communication between the processing units (e.g., accelerators) and staging data in and out of external storage which, as noted above, may limit bandwidth utilization, transmission speeds and latency, and scalability, and increases the power and cost of the system.

Accordingly, the inventors have developed systems and techniques for leveraging OCS devices to provide dynamic connectivity in disaggregated memory schemes. The OCS devices allow for the processing units (e.g., GPUs, CPUs, TPUs or accelerators) to shift bandwidth from processing unit to processing unit configurations to one or more of the disaggregated memory devices. The systems and techniques can make the shift using low-hop count (or even direct connect), low latency paths, increasing the performance over conventional static disaggregated memory systems. Further, redirecting the existing I/O of the accelerator in this manner avoids introducing additional components (e.g., transceivers, SerDes, external packet or circuit switches) that may be utilized in the conventional fixed stage architectures and as such utilize less power over those conventional systems.

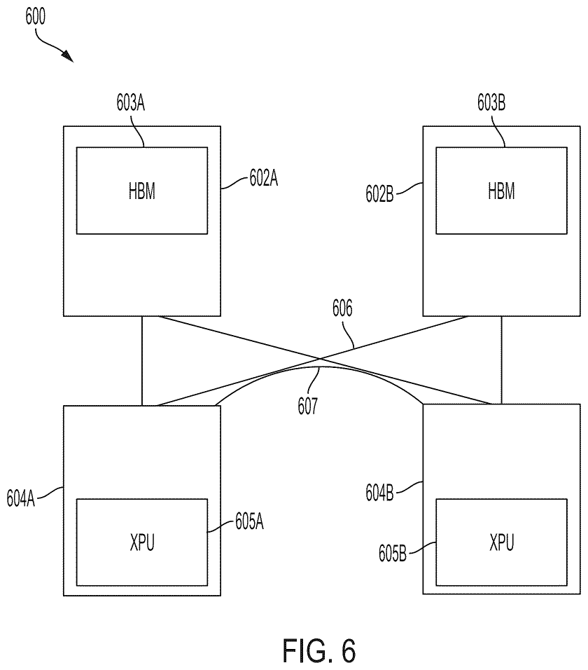

FIG. 6 is a block diagram of an example photonic computing system 600 having disaggregated memory, according to some embodiments. As shown in FIG. 6, the photonic computing system 600 includes a plurality of PICs, including a first set of PICs 602A and 602B and a second set of PICs 604A and 604B. PICs 602A and 602B are coupled to respective memory units 603A and 603B. In the illustrated embodiments, memory units 603A and 603B comprise HBMs although the technology is not limited in this manner. PICs 604A and 604B are coupled to respective electronic processing units 605A and 605B. The electronic processing units 605A and 605B may be any suitable processing unit, including for example, CPUs, GPUs, TPUs, or any other suitable processing unit. Further, in some embodiments, electronic processing units 605A and 605B may include at least one internal memory unit. Although illustrated as separate, it can be appreciated that the PICS of one or both sets may be reticle stitched to form an integrated chip. Further, the photonic processing system 600 is not limited to four PICs and any suitable number of PICs may be included and connected in the manner shown.

The photonic processing system 600 further includes a plurality of optical fibers coupling the various PICs of the system. Optical fibers 606 may be configured to couple PICs of the first set (602A and 602B) to PICS of the second set (604A and 604B) whereas optical fibers 607 may couple PICs of the second set to other PICS of the second set (e.g., 604A with 604B). In the illustrated embodiment, either of PIC 604A and 604B may be coupled to both PICs 602A and 602B as well as any other PIC 602 or 604 in the system. In that way, bandwidth can be switched between processing units and memory as well as between two processing units to maximize usage of both scale-out and scale-up bandwidth and enable dynamic memory expansion for the processing units.

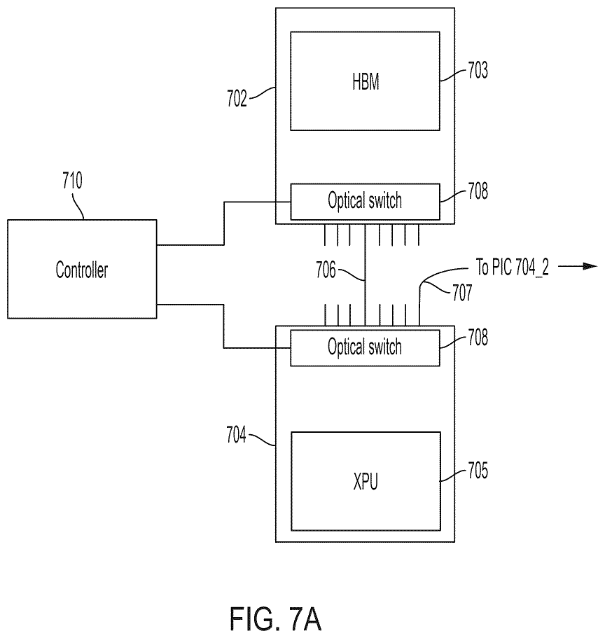

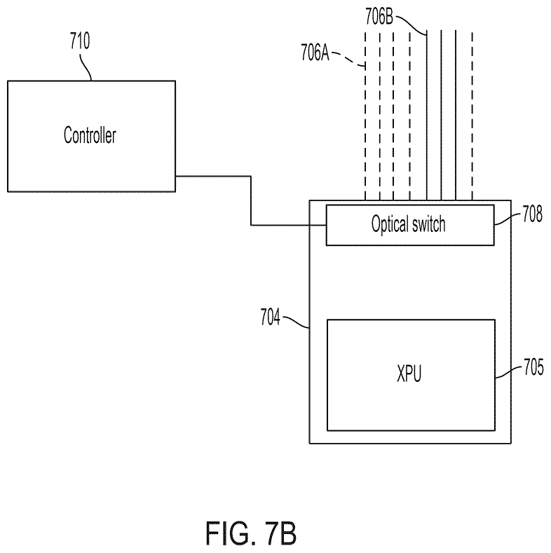

FIG. 7A is a block diagram of a subsection of the example system of FIG. 6, according to some embodiments. FIG. 7B is a block diagram of a subsection of the example system of FIG. 6 depicting dark and lit optical fibers, according to some embodiments. Dark fibers 706A are those fibers that are inactive (e.g., where the optical connections of optical switch 708 are set to the inactive configuration). Lit fibers 706B are those where the optical connections are set to the active configuration

In the illustrated embodiment, optical coupling between the various PICs 702 and 704 may be controlled using optical switches 708. Each PIC of the first set of PICs 702 and the second set of PICs 704 includes an optical switch 708 between which optical fibers 706 and 707 may be coupled. The optical switches 708 may include optical connections (e.g., inputs/outputs) to which the fibers may be coupled.

Controller 710 may control optical switches 708 to dynamically establish connections between various PICs in the system. For example, when an optical signal is to be transmitted between two PICs, controller 710 may determine which fiber and optical connections of the optical switches 708 are associated with the connection between those two PICs. Controller 710 may then control the optical switches 708 to set the determined optical connections to an active configuration (turning a dark fiber 706A into a lit fiber 706B), allowing the optical signal to be transmitted between the two PICs. Other optical connections may be set to the inactive configuration, making the fibers dark and preventing optical signals from being transmitted through undesired fibers.

In some embodiments, the controller 710 may control optical switches 708 to distribute bandwidth between multiple processing units 705 and/or allocate the external memory units 703 to various processing units 705 of the system. For example, for a first process to be executed by electronic processing unit 705, controller 710 may determine the memory resources needed for the process and allocate memory unit(s) 703 to electronic processing unit 705 accordingly. Controller 710 can further re-allocate various memory unit(s) 703 as the system executes more processes as well as turn on and off processing unit-to-processing unit connections, enabling a network that can dynamically manage bandwidth distribution and component utilization efficiency throughout the system.

In some embodiments, processing unit-to-processing unit connections are desired. Controller 710 may thus control optical switch 708 to set the optical connections associated with the first set of optical fiber 706 to the inactive configuration and set the optical connections associated with the second set of optical fibers 707 to the active configuration. Additionally or alternatively, processing unit-to-memory unit connections are desired (e.g., when more memory bandwidth is required to execute a process). Controller 710 may thus control optical switch 708 to set the optical connections associated with the second set of optical fiber 707 to the inactive configuration and set the optical connections associated with the first set of optical fibers 706 to the active configuration.

FIG. 8 is a block diagram illustrating an example implementation of an optical switch, according to some embodiments. In this example, optical switch 708 includes a plurality of 2×2 optical switches 802 arranged in a plurality of stages including six stages: stage 1, stage 2, stage 3, stage 4, stage 5, and stage 6. In some embodiments, optical switches 802 are directional couplers, where the directional couplers of stage 2 are coupled to outputs of the directional couplers of stage 1 and to inputs of the directional couplers of stage 3. Similarly, the directional couplers of stage 3 are coupled to outputs of the directional couplers of stage 2 and to inputs of the directional couplers of stage 4, and so on through stage 6. As shown in FIG. 8, optical switch 708 includes six stages, which equals 2×(Log₂(N)−1) stages, where N (=16) represents the number of inputs and outputs of optical switch 708. Each directional coupler in this example includes two inputs and two outputs, and may operate as a 3 dB coupler in each direction (although other coupling ratios are possible). The directional coupler may be passive (whereby the coupling ratios are fixed) or active (whereby the coupling ratios are variable, for example using the thermo-optic effect or the electro-optic effect). Other optical switching networks may be implemented using couplers other than 2×2 directional couplers, including for example multi-mode interferometers (MMI) and arrayed waveguide arrays (AWG).

It should also be noted that the optical switch 708 is implemented as a Benes architecture. Other embodiments may include optical switching networks implemented as a butterfly network, which may include only stages 1-4 (Log₂(N) stages), or any other suitable architecture.

### V. Example Computer Systems

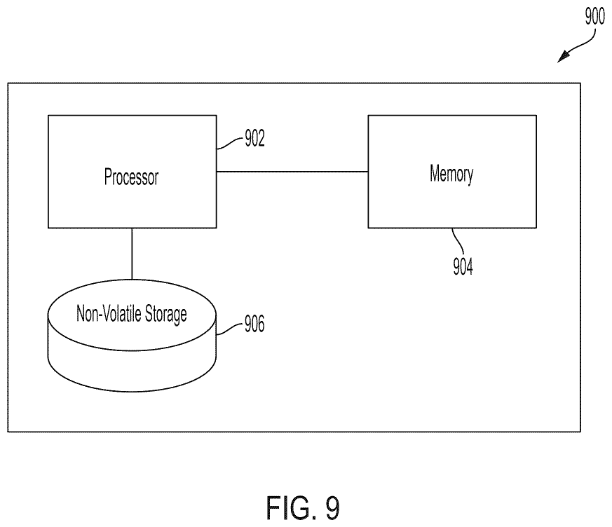

FIG. 9 is an example computer system that may be used to implement some of the controllers described herein. The computing device 900 may include one or more computer hardware processors 902 and non-transitory computer-readable storage media (e.g., memory 904 and one or more non-volatile storage devices 906). The processor(s) 902 may control writing data to and reading data from (1) the memory 904; and (2) the nonvolatile storage device(s) 906. To perform any of the functionality described herein, the processor(s) 902 may execute one or more processor-executable instructions stored in one or more non-transitory computer-readable storage media (e.g., the memory 904), which may serve as non-transitory computer-readable storage media storing processor-executable instructions for execution by the processor(s) 902.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform tasks or implement abstract data types. Typically, the functionality of the program modules may be combined or distributed.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments. The definitions, as defined and used herein, should be understood to control over dictionary definitions, definitions in documents incorporated by reference and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some case and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately,” “substantially,” and “about” may be used to mean within ±20% of a target value in some embodiments. The terms “approximately,” “substantially,” and “about” may include the target value.

Use of ordinal terms such as “first,” “second,” “third,” etc., in the claims to modify a claim element does not by itself connotate any priority, precedence, or order of one claim element over another or the temporal order in which acts of a method are performed, but are used merely as labels to distinguish one claim element having a certain name from another claim element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The terms “couple,” “coupled,” and “coupling,” when used in connection with optical components, are to be interpreted broadly to include both direct and indirect coupling. Two optical components are considered directly coupled if there are no intervening components between them. In contrast, two optical components are considered indirectly coupled if there is at least one intervening component between them, provided that the intervening component does not alter the general nature of the interaction between the optical components.

What is claimed is:

1. A system comprising:
a first plurality of photonic integrated circuits (PICs), each PIC of the first plurality being coupled to at least one high bandwidth memory (HBM);
a second plurality of PICs, each PIC of the second plurality being coupled to at least one electronic processing unit; and
a first plurality of optical fibers coupling the first plurality and second plurality of PICs.

2. The system of claim 1, further comprising a second plurality of optical fibers coupling PICs of the second plurality with other PICS of the second plurality.

3. The system of claim 2, wherein each of the PICS of the first plurality and second plurality comprises an optical switch coupled to at least some of the first plurality of optical fibers and at least some of the second plurality of optical fibers.

4. The system of claim 3, further comprising at least one controller configured to control the optical switches, wherein the controller is configured to control the optical switches by:
switching a first optical connection of the optical switch from an inactive configuration to an active configuration to enable optical signals to be transmitted through a first optical fiber of the first plurality of optical fibers or a first optical fiber of the second plurality of optical fibers or from the active configuration to the inactive configuration to prevent optical signals from being transmitted through the first optical fiber.

5. The system of claim 4, wherein the controller is configured to control the optical switches by:
setting optical connections of the optical switches associated with the first plurality of optical fibers to an active configuration; and
setting optical connections of the optical switches associated with the second plurality of optical fibers to an inactive configuration.

6. The system of claim 4, wherein the controller is configured to control the optical switches by:
setting optical connections of the optical switches associated with the second plurality of optical fibers to an active configuration; and
setting optical connections of the optical switches associated with the first plurality of optical fibers to an inactive configuration.

7. The system of claim 3, wherein the optical switches each comprise a plurality of 2×2 optical switches arranged in a Benes architecture.

8. The system of claim 7, wherein the plurality of 2×2 optical switches comprise directional couplers.

9. The system of claim 1, wherein each PIC of the first and second plurality comprises at least one electro-optical transceiver configured to:
generate an electrical signal based on a received optical signal; and
generate an optical signal based on a received electrical signal.

10. The system of claim 1, wherein each electronic processing unit comprises at least one internal memory.

11. The system of claim 1, wherein the first and second pluralities of PICs are reticle stitched.

12. A method for dynamically configuring a system, the system comprising a first plurality of photonic integrated circuits (PICs), each PIC of the first plurality being coupled to at least one high bandwidth memory (HBM), a second plurality of PICs, each PIC of the second plurality being coupled to at least one electronic processing unit, and a first plurality of optical fibers coupling the first plurality and second plurality of PICs, the method comprising:
setting optical connections associated with the at least one optical fiber of the first plurality of optical fibers to an active configuration, the active configuration enabling optical signals to be transmitted between a first PIC of the first plurality and a first PIC of the second plurality; and
setting optical connections associated with other optical fibers of the first plurality of optical fibers to an inactive configuration, the inactive configuration preventing optical signals from being transmitted between the PICS of the first plurality and PICs of the second plurality associated with the other optical fibers.

13. The method of claim 12, wherein the system comprises a controller and each PIC of the first plurality of PICs and second plurality of PICs comprises an optical switch coupled to some of the first plurality of optical fibers, the method further comprising:
receiving, with the controller, a signal indicating the at least one optical fiber of the first plurality of optical fibers to be set to the active configuration; and
controlling the optical switches coupled with the at least one optical fiber to set the optical connections associated with the at least one optical fiber to the active configuration.

14. The method of claim 13, wherein the system further comprises a second plurality of optical coupling PICs of the second plurality of PICs with other PICs of the second plurality of PICs and the optical switches are each coupled to some of the second plurality of optical fibers, the method further comprising:
controlling the optical switches to set optical connections associated with the first plurality of optical fibers to the active configuration; and
controlling the optical switches to set optical connections associated with the second plurality of optical fibers to the inactive configuration.

15. The method of claim 13, wherein the system further comprises a second plurality of optical coupling PICs of the second plurality of PICs with other PICs of the second plurality of PICs and the optical switches are each coupled to some of the second plurality of optical fibers, the method further comprising:
controlling the optical switches to set optical connections associated with the first plurality of optical fibers to the inactive configuration; and
controlling the optical switches to set optical connections associated with the second plurality of optical fibers to the active configuration.

16. The method of claim 13, wherein controlling an optical switch comprises applying a signal to the optical switch to vary an optical property of the optical switch.

17. A non-transitory computer-readable medium storing instructions that, when executed by at least one processor, cause the processor to perform a method for dynamically configuring a system, the system comprising a first plurality of photonic integrated circuits (PICs), each PIC of the first plurality being coupled to at least one high bandwidth memory (HBM), a second plurality of PICs, each PIC of the second plurality being coupled to at least one electronic processing unit, and a first plurality of optical fibers coupling the first plurality and second plurality of PICs, the method comprising:
setting optical connections associated with the at least one optical fiber of the first plurality of optical fibers to an active configuration, the active configuration enabling optical signals to be transmitted between a first PIC of the first plurality and a first PIC of the second plurality; and
setting optical connections associated with other optical fibers of the first plurality of optical fibers to an inactive configuration, the inactive configuration preventing optical signals from being transmitted between the PICS of the first plurality and PICs of the second plurality associated with the other optical fibers.

18. The non-transitory computer-readable medium of claim 17, wherein the system comprises a controller and each PIC of the first plurality of PICs and second plurality of PICS comprises an optical switch coupled to some of the first plurality of optical fibers, the method further comprising:
receiving, with the controller, a signal indicating the at least one optical fiber of the first plurality of optical fibers to be set to the active configuration; and
controlling the optical switches coupled with the at least one optical fiber to set the optical connections associated with the at least one optical fiber to the active configuration.

19. The non-transitory computer-readable medium of claim 17, wherein the system further comprises a second plurality of optical coupling PICs of the second plurality of PICs with other PICs of the second plurality of PICs and the optical switches are each coupled to some of the second plurality of optical fibers, the method further comprising:
controlling the optical switches to set optical connections associated with the first plurality of optical fibers to the active configuration; and
controlling the optical switches to set optical connections associated with the second plurality of optical fibers to the inactive configuration.

20. The non-transitory computer-readable medium of claim 17, wherein the system further comprises a second plurality of optical coupling PICs of the second plurality of PICs with other PICs of the second plurality of PICs and the optical switches are each coupled to some of the second plurality of optical fibers, the method further comprising:
controlling the optical switches to set optical connections associated with the first plurality of optical fibers to the inactive configuration; and
controlling the optical switches to set optical connections associated with the second plurality of optical fibers to the active configuration.
